(19) United States
(12) Patent Application Publication
(10) Pub. No.: US 2004/0171687 A1
(43) Pub. Date: Sep. 2, 2004

(54) Sporicidal composition

(75) Inventors: Maurice C. Kemp, Rocklin, CA (US); Robert Blaine Lalum, Antelope, CA (US); Rafael Jimenez, San Luis Obispo, CA (US); David Lewis, Eau Claire, WI (US)

Correspondence Address: T. Ling Chwang, Jackson Walker L.L.P., Suite 600, 2435 N. Central Expressway, Richardson, TX, 75080, US

(73) Assignee: Mionix Corp., Rocklin, CA

(21) Appl. No.: 10/697,997

(22) Filed: Oct. 30, 2003

Related U.S. Application Data
(60) Provisional application No. 60/423,134, filed on Nov. 1, 2002.

(51) Int. Cl. A01N 37/00

(52) U.S. Cl. 514/557

(57) ABSTRACT

A sporicidal composition prepared by mixing ingredients including: (1) a mono-carboxylic acid compound; (2) a non-ionic peroxide or its conjugate base; (3) a salt of an inorganic mono-peroxy acid; and (4) an aqueous acidic solution or fine suspension to give a pH of from about 0.5 to about 3.0 in the sporicidal composition.

This application claims priority to U.S. Provisional Patent Application Serial No. 60/423,134, entitled “Sporicidal Composition,” filed on Nov. 1, 2002, the entire content of which is hereby incorporated by reference.

### BACKGROUND

This invention pertains to a sporicidal solution, suspension, or composition. More specifically, this invention pertains to an acidic solution, suspension, or composition that has sporicidal properties.

When one or more nutrients becomes limiting for growth, bacteria of the genus Bacillus can initiate the process of sporulation. The spore coat and cortex are relatively impermeable, thus restricting access of potentially lethal molecules into the spore core. These characteristics, along with the fact that the interior, or core, of endospores is virtually devoid of water, make them extremely resistant to death due to environmental stresses. Spores are, therefore, much more resistant than their growing cell counterparts to a variety of environmental stresses, including heat, radiation and chemicals, and they can survive in a metabolically dormant state for extremely long periods of time.

An endospore is a structure that is formed inside (“endo”) certain types of bacteria. These internal structures contain DNA and the enzymatice machinery necessary for reproduction, and confer on the bacterial cell the ability to withstand environmental stressors such as heat, chemical, and dehydration. A cell that lacks an endospore is called a vegetative cell. Once a mature endospore is formed, the rest of the cell surrounding it is called the sporangium (singular; plural, sporangia). Various types of endospore-forming bacteria, usually rod-shaped, characteristically form endospores at particular locations in the rod (central, subterminal-near the ends of the rod, terminal-at the ends of the rod). After forming an endospore, the sporangium may die and eventually disintegrate. If the resulting spore retains no visible evidence of the sporangium, it is called a free spore.

There are five currently known genera of bacteria that form endospores. Most are rod-shaped and gram-positive. Of these, Bacillus and Clostridium are the most commonly encountered by the clinical microbiology laboratory. Endospores and free spores are large enough to be seen with a good light microscope but since they are impervious to many chemicals, they are not stained by the Gram's stain. The Malachite green spore stain uses heat to force stain into the spores. A decolorization step and counterstaining shows the vegetative cells in the smear. The absence of endospores does not necessarily mean that an unknown bacterium is not one of these genera. Cultures do not form endospores during rapid growth, only at the end of exponential growth. Also, cells need certain nutrients before they form endospores. Therefore, cells may have the genes necessary for endospore formation yet not express them.

Endospores are very resistant to environmental stresses that kill vegetative bacterial cells. Bacterial endospores are resistant to extreme desiccation, high temperatures, ionizing radiation, and penetration by chemicals. As an endospore matures inside the sporangium, it becomes desiccated, so mature endospores contain much less water than vegetative cells. It is thought that the components of a mature endospore are in a very dry, almost crystalline-like state, even when suspended in a fluid. Perhaps the most significant endospore characteristic, from a microbiologist's standpoint, is its resistance to high temperatures. Endospore suspensions can be heated to 63° C. (or 145° F.) for 35 minutes without killing the endospores. Some types of endospores even withstand temperatures of boiling water (100° C. or 212° F.) for extended periods of time. On the other hand, these amounts of heat kill vegetative cells and non-spore-forming bacteria.

Pathogenic spore-forming bacteria like Bacillus anthracis, Clostridium botulinum, C. Difficile, C. Perfringens and C. tetani form spores which survive in harsh environmental conditions for extended periods of time. The spore nucleoid structure is surrounded by protective layers composed of peptidoglycan and proteins with unusual amino acids content. This structure provides unique resistance properties acting as a permeability barrier to prevent access to the underlying spore protoplast. Spores are able to survive exposure to chlorinated solvents, determents, mechanical disruption, extreme temperatures, UV and ionizing radiation. These organisms can be bioengineered to maximize pathogenicity and the spores are easily weaponized and stored. The possible use of spores in bio-warfare or terrorist activities argues for broad-spectrum decontamination formulation for personnel, equipment and environment.

Endospore formers found in our environment exhibit various degrees of disease-causing potential, or virulence, for human hosts. For example, filly virulent Bacillus anthracis are encapsulated and toxigenic. These bacteria contain two transferable plasmids, pXO1 and pXO2, carrying genes for toxins (pag, lef and cya) and for capsular biosynthetic enzymes. Isolates lacking both pXO1 and pXO2 are indistinguishable from B. cereus. This latter species is a common cause of highly fulminant post-traumatic and metastatic endophthalmitis. Virulence factors for this organism are multifactorial but a hemolysin (“HBL”) is thought to be involved. Based on genomic differences, a bacterial species generally includes strains with 70% or greater DNA-DNA relatedness. By this criterion, all of the members of the Bacillus cereus group (B. cereus, B. anthracis, B. thuringiensis, and B. mycoides) belong to one species.

The four species of the B. cereus group are often indistinguishable. B. anthracis is the causative agent of anthrax and is distinguished from B. cereus based on its pathogenicity for man and animals. However, a strain of B. anthracis that has lost its virulence would be identified as B. cereus. Similarly, B. thuringiensis is distinguished from B. cereus based on its pathogenicity for insect larvae. However, non-pathogenic strains are indistinguishable from B. cereus.

In all other respects, B. thuringiensis and B. cereus are virtually identical, and there are no differential features as there are for distinguishing B. anthracis from B. cereus.

Microorganisms vary in their resistance to destruction by physical or chemical means. A disinfectant that destroys bacteria may be ineffective against viruses or fungi. There are differences in susceptibility between gram-negative and gram-positive bacteria, and sometimes even between strains of the same species. Bacterial spores are more resistant to destruction than vegetative forms. Information on the susceptibility of a particular microorganism to disinfectants can be found in a material safety data sheet (“MSDS”) for that agent. MSDS's provide additional details such as health hazards associated with the microorganism, mode of transmission, containment requirements and spill response procedures.

There are generally few chemicals that are truly sporicidal in nature. Chlorine and iodine disinfectants belong to the halogen group. Chlorine eliminates both enveloped and nonenveloped viruses. Chlorine is not effective against spores unless associated with a halogen-releasing agent (“HRA”). Household bleach (5.25 percent NaClO), a common source, is cheap and readily available. It is typically diluted 1:128 to 1:32 with water (⅛ to 1/2 cup per gallon of water). Chlorine disinfectants corrode metals and deteriorate fabrics. Chlorine in high concentrations irritates the mucus membranes, eyes and skin.

Iodine and iodophors are simple chemical compounds. These compounds can be included in a time-release formulation and with soaps or surgical scrubs. Simple iodine tinctures (iodine+R—OH) do not contain a cleaning compound. Iodine and iodophors are bactericidal, sporicidal, virucidal and fungicidal. Iodine, like chlorine, is inactive in the presence of organic material and must be applied multiple times in order to thoroughly disinfect. Iodine tinctures can be very irritating to tissues, can stain fabric and be corrosive. “Tamed” iodines such as surgical scrubs and surgical disinfectants generally do not irritate tissues. Tamed iodines include Betadine®, Povidone, Wescodyne®, Virac and Prepodyne®. Others include One Step™ and Iosan®.

Oxidizing agents are also sporicidal. The activity of peroxides is greatest against anaerobic bacteria. Hydrogen peroxide is not virucidal and in some cases is damaging to tissues, resulting in a prolonged healing time. Hydrogen peroxide is useful for cleaning surgical sites after closure, but must be used sparingly to avoid penetrating suture lines, which would inhibit healing. Blended and/or stabilized peroxides can be used to disinfect equipment surfaces. Stabilized peroxides may be blended with iodophors or quaternary ammonia. Some products are effective against a much broader range of pathogens including both enveloped and nonenveloped viruses, vegetative bacteria, fungi and bacterial spores. Examples include Hyperox™ and Virkon® S.

Aldehydes have a wide germicidal spectrum. Glutaraldehydes are bactericidal, virucidal, fungicidal, sporicidal and parasiticidal. They have a moderated residual activity and are effective in the presence of moderate organic material. Glutaraldehyde disinfectants include Lysofume™ and Wavicide®-I/Wavicide®-06. Formaldehydes are very potent disinfectants, but can be highly toxic to people and animals. They are used only as a last resort and then under trained supervision in a well-ventilated setting. Therefore, there is a need to have an effective, yet safe sporicidal agent or solution.

### SUMMARY

One embodiment of the sporicidal composition of the present invention is prepared by mixing ingredients including: (1) a mono-carboxylic acid; (2) a non-ionic peroxide or its conjugate base; (3) a salt of an inorganic mono-peroxy acid; and (4) an aqueous acidic solution or fine suspension to give a pH of from about 0.5 to about 3.0 in the sporicidal composition.

### DETAILED DESCRIPTION

One aspect of the present invention pertains to a sporicidal composition that is acidic and yet safe to the animals. The acidic sporicidal composition is prepared by mixing ingredients comprising:

(1) a mono-carboxylic acid;

(2) a non-ionic peroxide or its conjugate base;

(3) a salt of an inorganic mono-peroxy acid; and

(4) an aqueous acidic solution or fine suspension to give a pH of from about 0.5 to about 3.0 in the sporicidal composition.

The mono-carboxylic acid for the sporicidal composition of the present invention can be of:

(a) a carboxylic acid of general formula R—CO₂H, wherein R is a straight-chain or branched-chain saturated alkyl group CₙH₂ₙ₊₁, wherein 0≦n≦9;

(b) a ketoacid of general formula R—COCO₂H, wherein R is a straight-chain or branched-chain saturated alkyl group CₙH₂ₙ₊₁, wherein 0≦n≦6;

(c) a half ester of a dicarboxylic acid of general formula R—OCO(CH₂)ₓCO₂H, wherein 0≦x≦6, and wherein R is a straight-chain or branched-chain saturated alkyl group CₙH₂ₙ₊₁, wherein 0≦n≦4; or

(d) a mixture thereof.

The carboxylic acid R—CO₂H can be butyric acid, octanoic acid, propanoic acid, or a mixture thereof. The ketoacid R—COCO₂H can be pyruvic acid or oxaloacetic acid. The half ester of a dicarboxylic acid R—OCO(CH₂)ₙCO₂H can be monoethyl succinate, monoethyl glutarate, or a mixture thereof.

The non-ionic peroxide or its conjugate base can be hydrogen peroxide, tert-butyl hydroperoxide, benzoyl peroxide, or a mixture thereof. Preferably, the non-ionic peroxide or its conjugate base is hydrogen peroxide (30% strength).

The salt of an inorganic mono-peroxy acid can be an alkali metal salt of peroxymonosulfate, persulfate, perborate, peroxymonophosphate, or a mixture thereof. Preferably, the salt of an inorganic mono-peroxy acid is an alkali metal salt of monopersulfate, such as potassium peroxymonosulfate. One example is Oxone® (Aldrich Chemical Co., Milwaukee, Wis., or Sigma Chemical Company, St. Louis, Mo.), which is a monopersulfate compound. Other examples of the salt of an inorganic mono-peroxy acid include potassium persulfate, potassium perborate and potassium peroxymonophosphate.

Examples of the aqueous acidic solution or suspension include an acidic solution of sparingly soluble group IIA complexes (“AGIIS”), a highly acidic metalated organic acid (“HAMO,” preferably generated in situ), a highly acidic metalated mixture of inorganic acids (“HAMMIA”), hydrochloric acid, sulfuric acid, phosphoric acid, sulfonic acid, and derivatives thereof.

The aqueous acidic solution or suspension is used to adjust the pH of the sporicidal composition to be in a range of from about 0.5 to about 3.0, preferably from about 0.5 to about 2.0, and more preferably from about 1.0 to about 1.5.

AGIIS

The acidic, or low pH, solution of sparingly soluble Group IIA complexes (“AGIIS”) may have a suspension of very fine particles, and the term “low pH” means the pH is below 7, in the acidic region. The AGIIS has a certain acid normality but does not have the same dehydrating behavior as a saturated calcium sulfate in sulfuric acid having the same normality. The AGIIS has a certain acid normality but does not char sucrose as readily as does a saturated solution of calcium sulfate in sulfuric acid having the same normality. Further, the AGIIS has low volatility at room temperature and pressure. It is less corrosive to a human skin than sulfuric acid saturated with calcium sulfate having the same acid normality. Not intending to be bound by the theory, it is believed that one embodiment of AGIIS comprises near-saturated, saturated, or super-saturated calcium sulfate anions or variations thereof, and/or complex ions containing calcium, sulfates, and/or variations thereof.

The term “complex,” as used herein, denotes a composition wherein individual constituents are associated. “Associated” means constituents are bound to one another either covalently or non-covalently, the latter as a result of hydrogen bonding or other inter-molecular forces. The constituents may be present in ionic, non-ionic, hydrated or other forms.

The AGIIS can be prepared in several ways. Some of the methods involve the use of Group IA hydroxide but some of syntheses are devoid of the use of any added Group IA hydroxide, although it is possible that a small amount of Group IA metal may be present as “impurities.” The preferred way of manufacturing AGIIS is not to add Group IA hydroxide to the mixture. As the phrase implies, AGIIS is highly acidic, ionic, with a pH of below about 7, preferably below about 2.

A preferred method of preparing AGIIS involves mixing a mineral acid with a Group IIA hydroxide, or with a Group IIA salt of a dibasic acid, or with a mixture of the two Group IIA materials. In the mixing, a salt of Group IIA is also formed. Preferably, the starting Group IIA material or materials selected will give rise to, and form, the Group IIA salt or salts that are sparingly soluble in water. The preferred mineral acid is sulfuric acid, the preferred Group IIA hydroxide is calcium hydroxide, and the prefer Group IIA salt of a dibasic acid is calcium sulfate. Other examples of Group IIA salt include calcium oxide, calcium carbonate, and “calcium bicarbonate.”

Thus, for example, AGIIS can be prepared by mixing or blending starting materials given in one of the following scheme with good reproducibility:

(1) H₂SO₄ and Ca(OH)₂;

(2) H₂SO₄, Ca(OH)₂, and CaCO₃;

(3) H₂SO₄, Ca(OH)₂, CaCO₃, and CO₂ (gas);

(4) H₂SO₄, CaCO₃, and Ca(OH)₂;

(5) H₂SO₄, Ca(OH)₂, and CaSO₄;

(6) H₂SO₄, CaSO₄, CaCO₃, and Ca(OH)₂;

(7) H₂SO₄, CaSO₄, CaCO₃, and CO₂ (gas); and

(8) H₂SO₄, CaSO₄, CaCO₃, CO₂ (gas), and Ca(OH)₂.

Preferably, AGIIS is prepared by mixing calcium hydroxide with concentrated sulfuric acid, with or without an optional Group IIA salt of a dibasic acid (such as calcium sulfate) added to the sulfuric acid. The optional calcium sulfate can be added to the concentrated sulfuric acid prior to the introduction of calcium hydroxide into the blending mixture. The addition of calcium sulfate to the concentrated sulfuric acid appears to reduce the amount of calcium hydroxide needed for the preparation of AGIIS. Other optional reactants include calcium carbonate and gaseous carbon dioxide being bubbled into the mixture. Regardless of the use of any optional reactants, it was found that the use of calcium hydroxide is desirable.

One preferred method of preparing AGIIS can be described briefly as: Concentrated sulfuric acid is added to chilled water (8°-12° C.) in the reaction vessel, then, with stirring, calcium sulfate is added to the acid in chilled water to give a mixture. Temperature control is paramount to this process. To this stirring mixture is then added a slurry of calcium hydroxide in water. The solid formed from the mixture is then removed. This method involves the use of sulfuric acid, calcium sulfate, and calcium hydroxide, and it has several unexpected advantages. Firstly, this reaction is not violent and is not exceedingly exothermic. Besides being easy to control and easy to reproduce, this reaction uses ingredients each of which has been reviewed by the U.S. Food and Drug Administration (“U.S. FDA”) and determined to be “generally recognized as safe” (“GRAS”). As such, each of these ingredients can be added directly to food, subject, of course, to certain limitations. Under proper concentration, each of these ingredients can be used as processing aids and in food contact applications. Their use is limited only by product suitability and Good Manufacturing Practices (“GMP”). The AGIIS so prepared is thus safe for animal consumption, safe for processing aids, and safe in food contact applications. Further, the AGIIS reduces biological contaminants in not only inhibiting the growth of, and killing, microorganisms but also destroying the toxins formed and generated by the microorganisms. The AGIIS formed can also preserve, or extend the shelf life of, consumable products, be they plant, animal, pharmaceutical, or biological products. It also preserves or improves the organoleptic quality of a beverage, a plant product or an animal product. It also possesses certain healing and therapeutic properties.

The sulfuric acid used for AGIIS is usually 95-98% FCC Grade (about 35-37 N). The amount of concentrated sulfuric acid can range from about 0.05 M to about 18 M (about 0.1 N to about 36 N), preferably from about 1 M to about 5 M. It is application specific. The term “M” used denotes molar or moles per liter.

Normally, in the preparation of AGIIS, a slurry of finely ground calcium hydroxide suspended in water (about 50% of w/v) is the preferred way of introducing the calcium hydroxide, in increments, into the a stirring solution of sulfuric acid, with or without the presence of calcium sulfate. Ordinarily, the reaction is carried out below 40° C., preferably below room temperature, and more preferably below 10° C. The time to add calcium hydroxide can range from about 1 hour to about 4 hours. The agitation speed can vary from about 600 to about 700 rpm or higher. After the mixing, the mixture is filtered through a 5 micron filter. The filtrate is then allowed to sit overnight and the fine sediment is removed by decantation.

The calcium hydroxide for the preparation of AGIIS is usually FCC Grade of about 98% purity. For every mole of concentrated acid, such as sulfuric acid, the amount, in mole, of calcium hydroxide used is application specific and ranges from about 0.1 to about 1.

The phosphoric acid used for AGIIS is usually from JT Baker of about 85-88%.

The calcium monohydrogen phosphate for AGIIS is usually of 98-99%; and the calcium phosphate (“the tribasic”) is obtained from Mallinckrodt. Other phosphate salts used are all of reagent grade.

The optional calcium carbonate for AGIIS is normally FCC Grade having a purity of about 98%. When used with calcium hydroxide as described above, for every mole of concentrated acid, such as sulfuric acid, the amount, in mole, of calcium carbonate ranges from about 0.001 to about 0.2, depending on the amount of calcium hydroxide used.

The optional carbon dioxide for AGIIS is usually bubbled into the slurry containing calcium hydroxide at a speed of from about 1 to about 3 pounds pressure. The carbon dioxide is bubbled into the slurry for a period of from about 1 to about 3 hours. The slurry is then added to the reaction vessel containing the concentrated sulfuric acid.

Another optional ingredient for AGIIS is calcium sulfate, a Group IIA salt of a dibasic acid. Normally, dihydrated calcium sulfate is used. As used in this application, the phrase “calcium sulfate,” or the formula “CaSO₄,” means either anhydrous or hydrated calcium sulfate. The purity of calcium sulfate (dihydrate) used is usually 95-98% FCC Grade. The amount of calcium sulfate, in moles per liter of concentrated sulfuric acid, ranges from about 0.005 to about 0.15, preferably from about 0.007 to about 0.07, and more preferably from about 0.007 to about 0.04. It is application specific.

In the preparation of AGIIS, in the event that CaSO₄ is used for the reaction by adding it to the solution of concentrated H₂SO₄, the amount of CaSO₄, in grams per liter of solution based on final volume, has the following relationship:

| Final AGIIS Acid Normality N | Amount of CaSO₄ in g/l |
|---|---|
| 1-5 | 5 |
| 6-10 | 4 |
| 11-15 | 3 |
| 16-20 | 2 |
| 21-36 | 1 |

The AGIIS obtained could have an acid normality range of from about 0.05 to about 31; the pH of lower than 0; boiling point of from about 100 to about 106° C.; freezing point of from about −8° C. to about 0° C.

AGIIS obtained from using the reaction of H₂SO₄/Ca(OH)₂/CaSO₄ had the following analyses (average):

AGIIS With Final Acid Normality of 1.2 N: pH of −0.08H₃O+, 2.22%; Ca, 602 ppm; SO₄, 73560 ppm; K, 1.36 ppb; impurities of 19.68 ppm, and neither Na nor Mg was detected.

AGIIS With Final Acid Normality of about 29 N: pH of about −1.46H₃O+, 30.68%; Ca, 52.9 ppm; SO₄, 7356000 ppm; K, 38.02 ppb; and neither Na nor Mg was detected.

Aqueous solutions of other alkalis or bases, such as Group IA hydroxide solution or slurry and Group IIA hydroxide solution or slurry can be used. Groups IA and IIA refer to the two Groups in the periodical table. The use of Group IIA hydroxide is preferred. Preferably, the salts formed from using Group IIA hydroxides in the reaction are sparingly soluble in water. It is also preferable to use only Group IIA hydroxide as the base without the addition of Group IA hydroxide.

After the preparation of the AGIIS, the resultant concentrated acidic solution with a relatively low pH value, typically below pH 1, can then be diluted with de-ionized water to the desired pH value, such as pH of about 1 or about 1.8.

As discussed above, AGIIS has relatively less dehydrating properties (such as charring sucrose) as compared to the saturated solution of CaSO₄ in the same concentration of H₂SO₄. Further, the stability and non-corrosive nature of the AGIIS of the present invention can be illustrated by the fact that a person can put his or her hand into this solution with a pH of less than 0.5 and, yet, his or her hand suffers no irritation, and no injury. If, on the other hand, one places his or her hand into a solution of sulfuric acid Of pH of less than 0.5, an irritation would occur within a relatively short span of time. A solution of 28 N of sulfuric acid saturated with calcium sulfate will cause chemical burn to a human skin after a few seconds of contact. In contrast, AGIIS solution of the same normality would not cause chemical burn to a human skin even after in contact for 5 minutes. The AGIIS does not seem to be corrosive when being brought in contact with the environmental protective covering of plants (cuticle) and animals (skin). AGIIS has low volatility at room temperature and pressure. Even as concentrated as 29 N, the AGIIS has no odor, does not give off fumes in the air, and is not irritating to a human nose when one smells this concentrated solution.

The preparation of AGIIS is the subject of a pending U.S. patent application Ser. No. 09/500,473, filed Feb. 9, 2000, the entire content of which is hereby specifically incorporated by reference.

HAMO

The highly acidic metalated organic acid (“HAMO”) may be a solution or may contain a suspension of very fine particles, and it has a monovalent or a polyvalent cation, an organic acid, and an anion of a regenerating acid, such as the anion of a strong oxyacid. The term “highly acidic” means the pH is in the acidic region, below at least about 4. HAMO is less corrosive to a ferrous metal than a solution of a mineral acid having the same acidic pH value as that of the acidic composition. HAMO is also more biocidal than a mixture of the organic acid and a metal salt of the organic acid which mixture having the same acid normality value as that of the acidic composition.

Broadly, one way HAMO can be prepared is by mixing the following ingredients: (1) at least one regenerating acid; (2) at least one metal base; and (3) at least one organic acid, wherein the equivalent amount of the regenerating acid is in excess of the equivalent amount of the metal base. The equivalent amount of the metal base should be about equal to that of the organic acid. Instead of using a metal base and an organic acid, a metal salt of the organic acid can be used in place of the metal base and the organic acid. The insoluble solid is removed by any conventional method, such as sedimentation, filtration, or centrifugation.

Thus, HAMO can be prepared by mixing: (1) a monovalent or polyvalent cation; (2) an organic acid generated from a salt of the organic acid; and (3) an anion of a strong oxyacid. More specifically, HAMO can be prepared by mixing ingredients comprising: (1) at least one regenerating acid having a first number of equivalents; (2) at least one metal base having a second number of equivalents; and (3) at least one salt of an organic acid having a third number of equivalents; wherein the first number of equivalents is greater than the sum of the second number of equivalents and the third number of equivalents.

Generally, HAMO can be prepared by blending or mixing the necessary ingredients in at least the following manners:

1. Regenerating acid+(metal base+organic acid);

2. Regenerating acid+(metal base+salt of organic acid);

3. (Regenerating acid+salt of organic acid)+base; and

4. Regenerating acid+salt of organic acid.

The parenthesis in the above scheme denotes “pre-mixing” the two ingredients recited in the parenthesis. Normally, the regenerating acid is added last to generate the HAMO. Although each of the reagents is listed as a single reagent, optionally, more than one single reagent, such as more than one regenerating acid or organic acid, can be used in the current invention. The number of equivalents of the regenerating acid must be larger than the number of equivalents of the metal base, or those of the metal salt of the organic acid.

When the organic acid is an amino acid, which, by definition contains at least one amino group, then the number of equivalents of the regenerating acid must be larger than the total number of equivalents of the metal base, or metal salt of the organic acid, and the “base” amino group of the amino acid. Thus, the resultant highly acidic metalated organic acid is different from, and not, a buffer.

As used herein, a regenerating acid is an acid that will “re-generate” the organic acid from its salt. Examples of a regenerating acid include a strong binary acid, a strong oxyacid, and others. A binary acid is an acid in which protons are directly bound to a central atom, that is, “central atom”-H. Examples of a binary acid include HF, HCl, HBr, H₁, H₂S and HN₃. An oxyacid is an acid in which the acidic protons are bound to oxygen, which in turn is bound to a central atom, that is “central atom”-O—H. Examples of oxyacids include acids having Cl, Br, Cr, As, Ge, Te, P, B, As, I, S, Se, Sn, Te, N, Mo, W, or Mn as the central atom. Some examples include H₂SO₄, HNO₃, H₂SeO₄, HClO₄, H₃PO₄, and HMnO₄. Some of the acids (e.g. HMnO₄) cannot actually be isolated as such, but occur only in the form of their dilute solutions, anions, and salts. A “strong oxyacid” is an oxyacid which at a concentration of 1 molar in water gives a concentration of H₃O⁺ greater than about 0.8 molar.

The regenerating acid can also be an acidic solution of sparingly soluble Group IIA complexes (“AGIIS”).

An organic acid for HAMO is an acidic compound containing carbon. It includes carboxylic acid, amino acid, acidic vitamin, sulfonic acid, phosphonic acid, and others. A carboxylic acid is an organic compound containing a —COOH group, i.e., a carbonyl attached to a hydroxyl group. A carboxylic acid can be a mono-carboxylic acid, a di-carboxylic acid, or a tri-carboxylic acid. A mono-carboxylic acid can be represented by a general formula of R¹—COOH, wherein R¹ can be: H; C₁-C₄ saturated alkyl; C₂-C₅ unsaturated alkyl with 2 or less double bonds; or C₂-Cs unsaturated alkyl with 2 or less triple bonds; CH₃CH(OH); HOCH₂(CHOH)₄; or R₂CH(NH₂), wherein R₂ is H, C₁-C₄ saturated alkyl, C₆H₅CH₂, p-HO—C₆H₄CH₂, H₂N(CH₂)₄, HOCH₂, or CH₃CHOH. A di-carboxylic acid can be represented by a general formula of HOOC—R³—COOH, wherein R³ can be: (CH₂)ₘ, in which m can be 1-3; (CH═CH); CH₂CH(OH)H(OH)C—CH(OH); or (CH₂)ₚCH(NH₂), in which p is 2 or 3. A tri-carboxylic acid can be represented by a general formula of HOOCR⁴(COOH)COOH, wherein R⁴ can be: CH₂C(OH)CH₂; or CH₂CHCH₂. Although some amino acids have been included in the general category of mono-carboxylic acid, it is known in the art that amino acids include: alanine; arginine; aspartic acid (asparagine); cysteine (cystine); glutamic acid (glutamine); glycine; histidine; hydroxylysine; hydroxyproline; isoleucine; leucine; lycine; mehtionine; phenylalanine; proline; serine; threonine; tryptophan; tyrosine; valine; aminoadipic acid; diaminobutyric; ornithine; pipecolic acid; sarcosine; and thiiodothyronine (thyroxine).

The metal base can be in the form of an OH^{—}, CO₃^{═}, HCO₃^{—}, or O^{═} salt. The metal can be a monovalent metal, a polyvalent metal, all transition and rare earth elements, Sn, Pb, or Bi. Examples of monovalent metals include elements in Group IA. The polyvalent metals can be a divalent metal or a trivalent metal. Examples of divalent metals include elements in Group IIA, except Be; and examples of trivalent metals include elements in Group IIIA, except B. Preferably the metal is Mn, Mg, Ca, Fe(II), Cu(II), Zn(II), Ce, Ni, Pd, Cr, Ti, Zr, Co, Al, Sn, Pb, Bi, V(III), Cd, Hg, Pt, Hf, and other first-row lanthanides, except Pm. More preferably, the metal is Mg, Ca, Fe(II), Cu(II), Zn, Cr, or Co.

Salts of an organic acid as used in this application include the salts of the metals, discussed above, salts of the organic acids, also discussed above, and others.

The preparation of HAMO is the subject of a pending U.S. patent application Ser. No. 09/655,131, filed Sep. 5, 2000, the entire content of which is hereby specifically incorporated by reference.

HAMMIA

The highly acidic metalated mixture of inorganic acids (“HAMMIA”) has an acidic pH, and can be isolated from a mixture prepared by mixing ingredients comprising a salt of phosphoric acid, and a preformed, or in-situ generated, solution or suspension of an acidic sparingly-soluble Group IIA complex (“AGIIS”), wherein the solution or suspension of AGIIS is in an amount sufficient to render the acidic pH of the composition to be less than about 2. HAMMIA can be isolated from a mixture prepared by mixing ingredients comprising a salt of phosphoric acid, and a preformed, or in-situ generated, solution or suspension of AGIIS, wherein the solution or suspension of AGIIS is in an amount in excess of the amount required to completely convert the salt of phosphoric acid to phosphoric acid.

The preparation of HAMMIA is the subject of a pending U.S. patent application Ser. No. 09/873,755, filed Jun. 4, 2001, the entire content of which is hereby specifically incorporated by reference.

The term “biocidal” means capable of destroying a biological contaminant. A “biological contaminant” is defined as a biological organism, or the product of a biological organism, such as toxin, or both, all of which contaminate the environment and useful products.

The term “sporicidal” means capable of destroying spores or endospores, such as those produced by bacteria such as Bacillus and Clostridium.

Preferably, the sporicidal composition of the present invention is prepared by mixing ingredients comprising: (1) butyric acid; (2) 30% hydrogen peroxide; (3) potassium monopersulfate (Oxone®); and (4) water acidified with an acidic solution such as 5 N AGIIS.

For 1 L of sporicidal composition, the amount of: (1) butyric acid can range from about 75 g to 90 g, preferably from about 82 g to about 87 g, and more preferably from about 80 g to about 85 g, and even more preferably is about 81.9 g, or about 85 mL; (2) 30% hydrogen peroxide can range from about 13 g to about 31 g, preferably from about 17 g to about 28 g, more preferably from about 20 g to about 25 g, and is even more preferably about 33.3 g, or about 20 mL; (3) potassium monopersulfate (Oxone®) can range from about 3 g to about 18 g, preferably from about 5 g to about 15 g, more preferably from about 7 g to about 13 g, and even more preferably is about 10 g; (4) water can range from about 830 mL to about 895 mL, preferably from about 845 mL to about 881 mL, more preferably from about 855 mL to about 880 mL, and even more preferably from about 875 mL to about 878 mL, the amount of which can depend on the amount of AGIIS used; and (5) 5N AGIIS from about 13 g to about 30 g, preferably from about 16 g to about 28 g, more preferably from about 19 g to about 25 g, and even more preferably from about 19 g to about 21.2 g.

### EXAMPLE 1

From about 875 mL (875 g) to about 877.5 mL (877.5 g) of water was acidified with from about 17 mL (19.04 g) to about 19 mL (21.28 g) of 5 N AGIIS solution to achieve an acidic solution with a pH value of about 1.1. To this acidic solution was added 20 mL (33.3 g) of 30% hydrogen peroxide, 85 mL (81.94 g) of butyric acid, and, at a very slow addition rate, 10 g of potassium monopersulfate having about 4.5% min active oxygen. The final mixture was mixed and allowed to blend to give the desired sporicidal composition.

Although not wanting to be bound by theory, it is believed that the addition of hydrogen peroxide is to slow down the degradation of the potassium monopersulfate into hydrogen peroxide.

### EXAMPLE 2

In evaluating one embodiment of the sporicidal composition or agent of this invention, it is important to measure the contact time of the agent with the spores. To this end, the efficiency of the agent was evaluated by allowing a spores solution to be in direct contact with the agent for a measured amount of time. Subsequently the spores were rinsed several times with water or buffer, so as to prevent the agent to act on the vegetative cell which was much more susceptible to the agent.

One embodiment of the sporicidal composition or agent of the present invention was tested using a procedure developed by the DPTC for testing solutions for sporicidal effectiveness.

Spores were prepared by traditional plate methods, isolation and cleaning of the spores from the mother cells. Resulting solution of spores were kept in desiccated media or mixed with different agents used for their dispersion. Each of the strains to be used were microbiologically characterized. More than one strain was used as surrogate models for B. anthracis.

A standardized solution of a spore mixture, including B. cereus, B. licheniformis, B. subtilis, and others, was aliquoted into the appropriate number of tubes and pelleted. The resuspended pellets were exposed to the agent for time frames of 30 seconds, and then 1, 2, 5, 10, and 15 minutes, before being deactivated by promptly diluting. An appropriate number of pellets were treated with a 100-ppm solution of chlorine as a control, in the same time frames. At least one pellet was treated as a blank, and treated only with sterile water. The resuspended solutions were pelleted and then rinsed several times to remove residual acid or chlorine. The spores were then resuspended in sterile water, diluted and plated in duplicate on TSA+2% starch. Chlorine controls were plated at 10⁻¹-10⁻⁴ and the acid was plated at 10⁻¹-10⁻⁶. The blank control was plated at 10⁻²-10⁻⁵. Plates were incubated at 37° C. for 24 hours, and observations were recorded in a laboratory notebook, maintained in the DPTC.

Results are tabulated below. The symbol “TNTC” means “too numerous to count.”

| Chlorine | | | | |
|---|---|---|---|---|
| Positive | | | | |
| Control | 10⁻¹ | 10⁻² | 10⁻³ | 10⁻⁴ |
| 30 sec. | TNTC/TNTC | TNTC/TNTC | TNTC/TNTC | 99/33 |
| 1 min. | TNTC/TNTC | TNTC/TNTC | 133/87 | 13/20 |
| 2 min. | TNTC/TNTC | 44/41 | 33/7 | 1/0 |
| 5 min. | 147/116 | 10/15 | 3/5 | 0/0 |
| 10 min. | TNTC/TNTC | TNTC/TNTC | 151/111 | 20/14 |
| 15 min. | TNTC/TNTC | 81/57 | 5/7 | 4/3 |

| | Sporicidal agent | | | | | |
|---|---|---|---|---|---|---|
| | 10⁻¹ | 10⁻² | 10⁻³ | 10⁻⁴ | 10⁻⁵ | 10⁻⁶ |
| 30 sec. | 14/17 | 10/28 | 0/0 | 1/12 | 0/0 | 0/0 |
| 1 min. | 10/10 | 0/2 | 0/0 | 0/1 | 0/0 | 0/0 |
| 2 min. | 6/13 | 2/0 | 0/0 | 0/0 | 0/0 | 0/0 |
| 5 min. | 199/213 | 2/0 | 1/0 | 0/83* | 0/0 | 0/0 |
| 10 min. | TNTC/TNTC | 20/22 | 3/6 | 3/1 | 0/0 | 0/0 |
| 15 min. | 1/1 | 1/0 | 0/0 | 0/0 | 0/0 | 0/1 |

*operator contamination

| Blank | 10⁻¹ | 10⁻² | 10⁻³ | 10⁻⁴ |
|---|---|---|---|---|
| CFU's | TNTC/TNTC | TNTC/TNTC | TNTC/TNTC | 106/117 |

| | |
|---|---|
| Spores/ml | 1.2 E⁷ |

As shown by the plate counts, there is a clear 3-log reduction in the number of organisms when the spores are treated at full concentration with the sporicidal composition or agent of the present invention. There is some variation in the reduction numbers that appears inconsistent with the treatment times. However, this is explained by the combined use of old and fresh spore pellets. There was a visual difference in the size of the pellet when comparing the older prepared pellets to the freshly prepared pellets. As there was still a clear reduction, this fact is considered of little consequence to the findings.

Viability Analysis

Traditional methods based on heat activation, germination and plating of spores were used. The object was to evaluate the spore lethality of the sporicidal composition of the present invention on a mix of Bacillus endospore-forming species from the DPTC collection of spore formers inoculated and dried into plastic bottles.

A spore suspension was made for the Bacillus species mix; both were enumerated at 10⁷ spores per ml. Nineteen plastic bottles were inoculated with 1 ml of the endospore mixture and three bottles were left clean as a negative control. The inoculated bottles were cleaned, i.e. washed and rinsed, by the sporicidal composition or agent of this invention. Three of the bottles sent were positive controls and did not undergo cleaning. A H₂O plus 1% Tween-80 mixture was added (100 ml) to each bottle. The bottles were heat shocked at 80° C. for 12 minutes. Ten-fold serial dilutions were prepared for each bottle and plated in duplicate. The plates were incubated at 45° C. for 48 hours.

All of the bottles cleaned by the one embodiment of sporicidal composition or agent of the present invention showed low numbers of bacteria. The lowest dilution, 10⁰, in all but one bottle had numbers less than countable numbers (25-250 CFU/ml) for the cleaned bottles. The numbers are shown below for bottles 1-12 and controls.

TABLE 1
Lethality of sanitizing agent

| BOTTLE | ORIGINAL CFU/ML | FINAL CFU/ML |
|---|---|---|
| Neg control | 0 | <1 |
| Neg control | 0 | <1 |
| Neg control | 0 | <1 |
| Pos control | 1.0 × 10⁷ | 1.54 × 10⁴ |
| Pos control | 1.0 × 10⁷ | 1.76 × 10⁴ |
| Pos control | 1.0 × 10⁷ | 1.65 × 10⁴ |
| 2 | 1.65 × 10⁴ | 8 |
| 4 | 1.65 × 10⁴ | <1 |
| 5 | 1.65 × 10⁴ | <1 |
| 6 | 1.65 × 10⁴ | <1 |
| 7 | 1.65 × 10⁴ | <1 |
| 8 | 1.65 × 10⁴ | <1 |
| 9 | 1.65 × 10⁴ | 5 |
| 10 | 1.65 × 10⁴ | <1 |
| 11 | 1.65 × 10⁴ | 5 |
| 12 | 1.65 × 10⁴ | 29 |
| 13 | 1.65 × 10⁴ | <1 |
| 14 | 1.65 × 10⁴ | <1 |

In this study, it was observed that endospore-forming Bacillus strains are susceptible to the cleaning process using one embodiment of the sporicidal composition or agent of the present invention. The lethality of the cleaning proved to be effective at 3 to 4 cycles of logarithmic reduction.

What is claimed is:

1. A sporicidal composition prepared by mixing ingredients comprising:
(a) a mono-carboxylic acid;
(b) a non-ionic peroxide or its conjugate base;
(c) a salt of an inorganic mono-peroxy acid; and
(d) an aqueous acidic solution or suspension to adjust the pH of the sporicidal composition to a value of from about 0.5 to about 3.0.

2. The sporicidal composition of claim 1, wherein the mono-carboxylic acid comprises:
(a) a carboxylic acid of general formula R-CO₂H, wherein R is a straight-chain or branched-chain saturated alkyl group CₙH₂ₙ₊₁, wherein 0≦n≦9;
(b) a ketoacid of general formula R-COCO₂H, wherein R is a straight-chain or branched-chain saturated alkyl group CₙH₂ₙ₊₁, wherein 0≦n≦6;
(c) a half ester of a dicarboxylic acid of general formula R-OCO(CH₂)ₙCO₂H, wherein 0≦x≦6, and wherein R is a straight-chain or branched-chain saturated alkyl group CₙH₂ₙ₊₁, wherein 0≦n≦4; or
(d) a mixture thereof.

3. The sporicidal composition of claim 2, wherein the carboxylic acid of general formula R-CO₂H comprises butyric acid, octanoic acid, propanoic acid, or a mixture thereof.

4. The sporicidal composition of claim 2, wherein the ketoacid of general formula R—COCO₂H comprises pyruvic acid.

5. The sporicidal composition of claim 2, wherein the ketoacid of general formula R—COCO₂H comprises oxaloacetic acid.

6. The sporicidal composition of claim 2, wherein the a half ester of a dicarboxylic acid of general formula R—OCO(CH₂)ₙCO₂H comprises monoethyl succinate, monoethyl glutarate, or a mixture thereof.

7. The sporicidal composition of claim 1, wherein the non-ionic peroxide or its conjugate base comprises hydrogen peroxide, tert-butyl hydroperoxide, benzoyl peroxide, or a mixture thereof.

8. The sporicidal composition of claim 1, wherein the salt of an inorganic mono-peroxy acid comprises a alkali metal salt of peroxymonosulfate, persulfate, perborate, peroxymonophosphate, or a mixture thereof.

9. The sporicidal composition of claim 1, wherein the aqueous acidic solution or suspension comprises an acidic solution of sparingly-soluble Group IIA complexes (“AGIIS”), a highly acidic metalated organic acid (“HAMO”), a highly acidic metalated mixture of inorganic acids (“HAMMIA”), or a mixture thereof.

10. The sporicidal composition of claim 1, wherein the aqueous acidic solution of suspension comprises an acidic solution of sparingly-soluble Group IIA complexes (“AGIIS”), sulfuric acid, hydrochloric acid, phosphoric acid, sulfonic acid, or a mixture thereof.

11. The sporicidal composition of claim 1, wherein the pH ranges from about 0.5 to about 2.0.

12. A sporicidal composition prepared by mixing ingredients comprising:
(a) a mono-carboxylic acid of:
(i) a carboxylic acid of general formula R-CO₂H, wherein R is a straight-chain or branched-chain saturated alkyl group CₙH₂ₙ₊₁, wherein 0≦n≦9;
(ii) a ketoacid of general formula R-COCO₂H, wherein R is a straight-chain or branched-chain saturated alkyl group CₙH₂ₙ₊₁, wherein 0≦n≦6;
(iii) a half ester of a dicarboxylic acid of general formula R—OCO(CH₂)ₙCO₂H, wherein 0≦x≦6, and wherein R is a straight-chain or branched-chain saturated alkyl group CₙH₂ₙ₊₁, wherein 0≦n≦4; or
(iv) a mixture thereof;
(b) a non-ionic peroxide or its conjugate base;
(c) a salt of an inorganic mono-peroxy acid; and
(d) an aqueous acidic solution or suspension to adjust the pH of the sporicidal composition to a value of from about 0.5 to about 3.0.

13. The sporicidal composition of claim 12, wherein the carboxylic acid of general formula R—CO₂H comprises butyric acid, octanoic acid, propanoic acid, or a mixture thereof.

14. The sporicidal composition of claim 12, wherein the ketoacid of general formula R—COCO₂H comprises pyruvic acid.

15. The sporicidal composition of claim 12, wherein the ketoacid of general formula R—COCO₂H comprises oxaloacetic acid.

16. The sporicidal composition of claim 12, wherein the a half ester of a dicarboxylic acid of general formula R—OCO(CH₂)ₙCO₂H comprises monoethyl succinate, monoethyl glutarate, or a mixture thereof.

17. The sporicidal composition of claim 12, wherein the non-ionic peroxide or its conjugate base comprises hydrogen peroxide, tert-butyl hydroperoxide, benzoyl peroxide, or a mixture thereof.

18. The sporicidal composition of claim 12, wherein the salt of an inorganic mono-peroxy acid comprises an alkali metal salt of peroxymonosulfate, persulfate, perborate, peroxymonophosphate, or a mixture thereof.

19. The sporicidal composition of claim 12, wherein the aqueous acidic solution or suspension comprises an acidic solution of sparingly-soluble Group IIA complexes (“AGIIS”), a highly acidic metalated organic acid (“HAMO”), a highly acidic metalated mixture of inorganic acids (“HAMMIA”), or a mixture thereof.

20. The sporicidal composition of claim 12, wherein the aqueous acidic solution or suspension comprises an acidic solution of sparingly-soluble Group IIA complexes (“AGIIS”), sulfuric acid, hydrochloric acid, phosphoric acid, sulfonic acid, or a mixture thereof.

21. The sporicidal composition of claim 12, wherein the pH ranges from about 0.5 to about 2.0.

22. A sporicidal composition prepared by mixing ingredients comprising:
(a) butyric acid;
(b) hydrogen peroxide;
(c) alkali metal salt of monopersulfate; and
(d) an aqueous acidic solution or suspension to adjust the pH of the sporicidal composition to a value of from about 0.5 to about 3.0.

23. The sporicidal composition of claim 22, wherein the aqueous acidic solution or suspension comprises an acidic solution of sparingly-soluble Group IIA complexes (“AGIIS”), a highly acidic metalated organic acid (“HAMO”), a highly acidic metalated mixture of inorganic acids (“HAMMIA”), or a mixture thereof.

24. The sporicidal composition of claim 22, wherein the aqueous acidic solution or suspension comprises an acidic solution of sparingly-soluble Group IIA complexes (“AGIIS”).

25. The sporicidal composition of claim 23, wherein the aqueous acidic solution or suspension comprises an acidic solution of sparingly-soluble Group IIA complexes (“AGIIS”), sulfuric acid, hydrochloric acid, phosphoric acid, sulfonic acid, or a mixture thereof.

26. The sporicidal composition of claim 23, wherein the pH ranges from about 0.5 to about 2.0.
